(19) United States
(12) Patent Application Publication
(10) Pub. No.: US 2007/0049235 A1
(43) Pub. Date: Mar. 1, 2007

(54) Apparatus and method for transmitting signals

(75) Inventor: Kye-hyun Kyung, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/509,732

(22) Filed: Aug. 25, 2006

(30) Foreign Application Priority Data
Aug. 26, 2005 (KR) 10-2005-0078880

(51) Int. Cl. H04B 1/26

(52) U.S. Cl. 455/313

(57) ABSTRACT

A signal transmission apparatus may transmit and receive a differential signal using transmission lines. The apparatus may include a transmitter and a receiver. The transmitter may transmit a mixed signal obtained by mixing the differential signal with a single ended signal. The receiver may restore the differential signal and the single ended signal from the mixed signal. An edge of the single ended signal may have a phase difference of about 90° with an edge of the differential signal. The signal transmission apparatus and method may transmit two signals through a single channel to reduce a circuit area.

### PRIORITY STATEMENT

This application claims the benefit of Korean Patent Application No. 10-2005-0078880, filed on Aug. 26, 2005, in the Korean Intellectual Property Office, the entire contents of which is incorporated herein by reference.

### BACKGROUND OF THE INVENTION

1. Field of the Invention

Example embodiments of the present invention relate to an apparatus and a method for transmitting signals. More particularly, example embodiments of the present invention relate to an apparatus and a method for simultaneously transmitting a plurality of signals through a single channel.

2. Description of the Related Art

In general, low voltage differential signaling (LVDS) is known as an interface for transmitting differential signals. LVDS may be used to transmit a difference between voltages of two transmission lines as a transmission signal. LVDS is conventionally used in many applications including the transmission of signals from a transmitter to a receiver. LVDS may transmit signals at relatively high speed with relatively low power and may have a low electromagnetic interference (EMI).

FIG. 1 is a block diagram of a conventional bidirectional transmitting/receiving system 100, which may include a low-voltage differential signal driver. Referring to FIG. 1, the bidirectional transmitting/receiving system 100 may perform bidirectional signal transmission between a first system 105 and a second system 145 using a differential signal. The first system 105 may include a first transmitter D11 transmitting differential signals, a first receiver R12 receiving differential signals and a first circuit 110 for providing differential signals to the first transmitter D11. Similarly, the second system 145 may include a second transmitter D12 transmitting differential signals, a second receiver R11 receiving differential signals and a second circuit 140 providing differential signals to the second transmitter D12. The first and second transmitters D11 and D12 and the first and second receivers R12 and R11 may be connected to a pair of transmission lines 120 and 130. A first termination resistor RT2 may be coupled to the first receiver R12 and arranged between the transmission lines 120 and 130, and a second termination resistor RT1 may be coupled to the second receiver and arranged between transmission lines 120 and 130.

Conventionally, if data is transmitted from the first circuit 110 to the second circuit 140, the data may be input to the first transmitter D11 from an output terminal OUT1 of the first circuit 110. The input data may be converted into a differential signal by the first transmitter D11 and may be transmitted to the second receiver R11 connected to the second system 145 through the transmission lines 120 and 130. The differential signal received by the second receiver R11 of the second system 145 may be converted into data and provided to an input terminal IN2 of the second circuit 140.

Conventionally, if data is transmitted from the second circuit 140 of the second system 145 to the first circuit 110 of the first system 145, the data may be input to the second transmitter D12 from an output terminal OUT2 of the second circuit 140. The input data may be converted into a differential signal by the second transmitter D12 and transmitted to the first receiver R12 connected to the circuit 110 of the first system 105 through the transmission lines 120 and 130. The differential signal received by the first receiver R12 may be converted into data and input to an input terminal IN1 of the first circuit 110.

However, as the frequency of a system clock signal increases and systems become more complicated, the number of signals transmitted between the systems may increase and the systems may require a plurality of transmitters and receivers to accommodate the increase in signals.

### SUMMARY

An example embodiment provides a signal transmission apparatus capable of simultaneously transmitting a plurality of signals through a single channel.

An example embodiment provides a signal transmission method for simultaneously transmitting a plurality of signals through a single channel.

An example embodiment provides a signal transmission apparatus transmitting and receiving a differential signal using transmission lines, which may include a transmitter and a receiver.

An example embodiment of a transmitter may be connected to transmission lines and may transmit a mixed signal obtained by mixing a differential signal with a single ended signal. An example embodiment of a receiver may be connected to transmission lines and may restore a differential signal and a single ended signal from a mixed signal including the differential signal and the single ended signal.

According to an example embodiment, an edge of the single ended signal has a phase difference of 90° relative to an edge of the differential signal. The frequency of the differential signal may be higher than the frequency of the single ended signal, and the DC level of the differential signal may be higher than that of the single ended signal.

An example embodiment of a transmitter may include a differential amplifier and a single ended signal generator. The differential amplifier may receive data, generate the differential signal and output the differential signal through an output terminal and an inverted output terminal. The single ended signal generator may receive single ended data and apply a current to the output terminal and the inverted output terminal or receive a current from the output terminal and the inverted output terminal to output the mixed signal from the output terminal and the inverted output terminal.

An example embodiment of a single ended signal generator may include a first transmission generator applying a current to the output terminal or receiving a current from the output terminal in response to a logic level of the single ended data, and a second transmission generator applying a current to the inverted output terminal or receiving a current from the inverted output terminal in response to the logic level of the single ended data.

An example embodiment of the first transmission generator may include first and second PMOS transistors connected in series between a third voltage source and the output terminal. The first and second PMOS transistors may be turned on or off in response to a first bias signal and inverted single ended data obtained by inverting the single ended data, respectively. The first transmission generator may also include first and second NMOS transistors connected in series between the output terminal and a second voltage source. The first and second NMOS transistor may be turned on or off in response to the inverted single ended data and a second bias signal, respectively.

An example embodiment of a second transmission generator may include third and fourth PMOS transistors connected in series between the third voltage source and the output terminal. The third and fourth PMOS transistors may be turned on or off in response to the first bias signal and the inverted single ended data, respectively. The second transmission generator may also include third and fourth NMOS transistors connected in series between the output terminal and the second voltage source. The third and fourth NMOS transistors may be turned on or off in response to the inverted single ended data and the second bias signal, respectively.

An example embodiment of a receiver may include a receiving differential amplifier restoring a differential signal from a mixed signal, and a single ended signal restoration unit restoring a single ended signal from the mixed signal.

An example embodiment of a single ended signal restoration unit may compare a difference between a reference voltage and a maximum value of the DC voltage of the mixed signal to a difference between the reference voltage and a minimum value of the DC voltage of the mixed signal and may determine the logic value of the single ended signal in response to the comparison result at a sampling point of the mixed signal.

An example embodiment of a single ended signal restoration unit may include a first restoration generator outputting a difference between the reference voltage and the voltage of a negative signal of the mixed signal to a restoration output terminal and an inverted restoration output terminal, and a second restoration generator outputting a difference between the reference voltage and the voltage of a positive signal of the mixed signal to the restoration output terminal and the inverted restoration output terminal.

An example embodiment of a first restoration generator may include first and second restoration transistors having first terminals connected in parallel with the third voltage source and gates receiving the reference voltage and the negative signal of the mixed signal, respectively. The first restoration generator may also include a third restoration transistor having a first terminal connected to the second terminals of the first and second restoration transistors, a second terminal connected to the second voltage source, and a gate to which a control bias signal is applied. The first terminal of the first restoration transistor may be connected to the restoration output terminal and the first terminal of the second restoration transistor may be connected to the inverted restoration output terminal

An example embodiment of a second restoration generator may include a fourth restoration transistor having a first terminal connected to the restoration output terminal and a gate receiving the reference voltage, a fifth restoration transistor having a first terminal connected to the inverted restoration output terminal and a gate receiving the positive signal of the mixed signal, and a sixth restoration transistor having a first terminal connected to the second terminals of the fourth and fifth restoration transistors, a second terminal connected to the second voltage source, and a gate to which the control bias signal is applied.

According to an example embodiment, a differential signal may be data of a semiconductor memory device and a single ended signal may be a command signal or an address signal of the semiconductor memory device.

An example embodiment provides a signal transmission apparatus, which may include a mixing unit and a restoration unit. The signal transmission apparatus may include and/or be connected to a channel.

An example embodiment of a mixing unit may mix two signals having a phase difference of 90° to produce a single mixed signal. An example embodiment of a restoration unit may restore the two signals from the mixed signal. A channel may be connected between the mixing unit and the restoration unit to transmit the mixed signal. The channel may include two transmission lines transmitting the differential signal.

An example embodiment of a signal transmission method is provided for transmitting a differential signal and a single ended signal using a single channel. The method may include mixing a differential signal with a single ended signal to obtain a mixed signal; transmitting a mixed signal through the single channel; restoring the differential signal and the single ended signal from the mixed signal. The frequency of the differential signal may be higher than the frequency of the single ended signal.

The transmitting of the mixed signal may include receiving data; generating the differential signal; outputting the differential signal through a desired and/or predetermined output terminal and an inverted output terminal; receiving single ended data; and mixing the differential signal with the single ended signal at the output terminal and the inverted output terminal based on current applied to the output terminal and the inverted output terminal or current received from the output terminal and the inverted output terminal.

The restoring of the differential signal and the single ended signal may include restoring the differential signal from the mixed signal; and comparing a difference between a reference voltage and a maximum value of the DC voltage of the mixed signal to a difference between the reference voltage and a minimum value of the DC voltage of the mixed signal; and determining the logic value of the single ended signal in response to the comparison result at a sampling point of the mixed signal.

An example embodiment provides a transmitter. The transmitter may include a differential amplifier generating a differential signal and outputting the differential signal through an output terminal and an inverted output terminal; and a single ended signal generator receiving single ended data and one of applying a current to the output terminal and the inverted output terminal and receiving a current from the output terminal and the inverted output terminal to output a mixed signal including the differential signal and a single ended signal from the output terminal and the inverted output terminal.

An example embodiment provides a receiver. The receiver may include a receiving differential amplifier restoring a differential signal from a mixed signal including the differential signal and a single ended signal; and single ended signal restoration unit restoring the single ended signal from the mixed signal.

An example embodiment provides a method of transmitting a signal. The method may include mixing a differential signal with a single ended signal to obtain a mixed signal; and transmitting the mixed signal through a single channel.

An example embodiment provides a method of receiving a signal. The method may include receiving a mixed signal including a differential signal and a single ended signal through a single channel; and restoring the differential signal and a single ended signal from the mixed signal

### BRIEF DESCRIPTION OF THE DRAWINGS

The above and other features and advantages of example embodiments will become more apparent by the following detailed description of example embodiments considered in conjunction with the attached drawings in which:

FIG. 1 is a block diagram of a conventional bidirectional transmitting/receiving system including a low-voltage differential signal driver;

FIG. 2 is a block diagram of an example embodiment of a signal transmission apparatus;

FIG. 3 is a circuit diagram of an example embodiment of the transmitter illustrated in FIG. 2;

FIG. 4A is a circuit diagram of an example embodiment of the receiving differential amplifier of the receiver illustrated in FIG. 2;

FIG. 4B is a circuit diagram of an example embodiment of the single ended signal restoration unit of the receiver illustrated in FIG. 2;

FIG. 5A is an example waveform diagram of a differential signal and a single ended signal generated in an example embodiment of a transmitter;

FIG. 5B is an example waveform diagram of a mixed signal obtained by mixing a differential signal and a single ended signal in accordance with an example embodiment;

FIG. 6A is an example waveform diagram of a differential signal and a single ended signal when there is no phase difference between the differential signal and the single ended signal; and

FIG. 6B is an example waveform diagram of a mixed signal obtained by mixing the differential signal and the single ended signal of FIG. 6A.

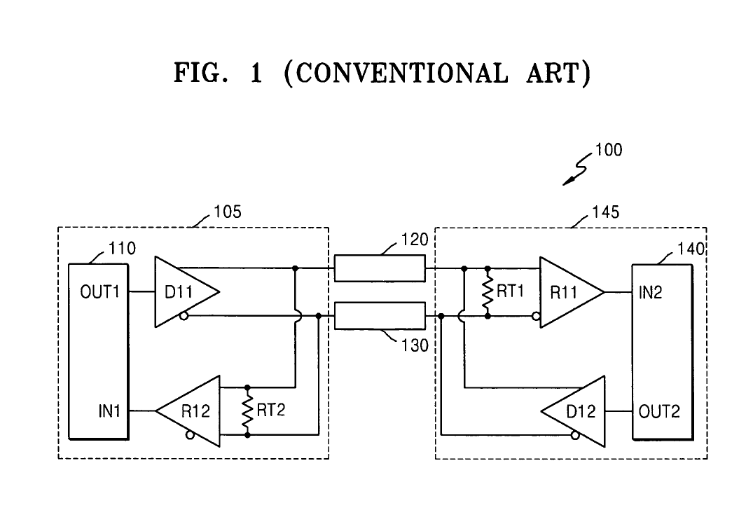

### DETAILED DESCRIPTION OF EXAMPLE EMBODIMENTS

Example embodiments are described more fully hereinafter with reference to the accompanying drawings. Embodiments may, however, be in many different forms and should not be construed as limited to the example embodiments set forth herein. Rather, these example embodiments are provided so that this disclosure will be thorough and complete, and will fully convey the scope to those skilled in the art. In the drawings, the size and relative sizes of components may be exaggerated for clarity. Throughout the drawings, like reference numerals refer to like components.

It will be understood that when a component is referred to as being “on,” “connected to” or “coupled to” another component, it can be directly on, connected to or coupled to the other component or intervening components may be present. In contrast, when a component is referred to as being “directly on,” “directly connected to” or “directly coupled to” another component, there are no intervening components present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the example embodiments.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

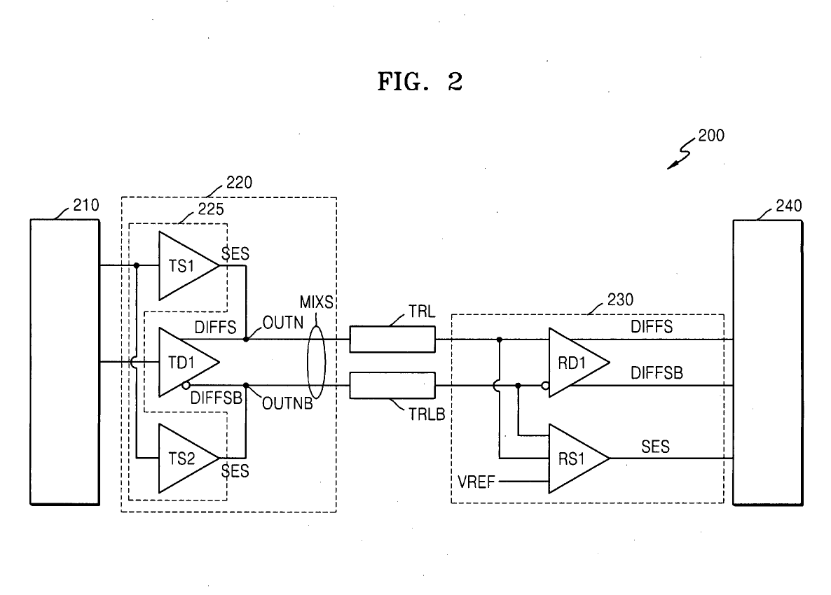

FIG. 2 is a block diagram of an example embodiment of a signal transmission apparatus 200. Referring to FIG. 2, the signal transmission apparatus 200 may have a low-voltage differential signal driver structure, which may transmit and receive a differential signal DIFFS and DIFFSB using transmission lines TRL and TRLB, for example. The signal transmission apparatus 200 may include a transmitter 220 and a receiver 230. A transmission system 210, which may apply data to the transmitter 220, and a receiving system 240, which may receive data restored by the receiver 230, are illustrated in FIG. 2 to facilitate description of example embodiments.

The transmitter 220 may be connected to one end of the transmission lines TRL and TRLB and may transmit a mixed signal MIXS obtained by mixing the differential signal DIFFS and DIFFSB with a single ended signal SES. The transmitter 220 may include a differential amplifier TD1 and a single ended signal generator 225. The differential amplifier TD1 may receive data (not shown), may generate the differential signal DIFFS and DIFFSB and may output the differential signal DIFFS and DIFFSB through an output terminal OUTN and an inverted output terminal OUTNB. The single ended signal generator 225 may receive single ended data (not shown), may apply a current to the output terminal OUTN and the inverted output terminal OUTNB or may receive a current from the output terminal OUTN and the inverted output terminal OUTNB to output the mixed signal MIXS from the output terminal OUTN and inverted output terminal OUTNB. The mixed signal MIX may be obtained by mixing the differential signals DIFFS and DIFFSB and the single ended signal SES, for example.

The single ended signal generator 225 may include a first transmission generator TS1 and a second transmission generator TS2. The first transmission generator TS1 may apply a current to the output terminal OUTN or may receive a current from the output terminal OUTN in response to a logic level of the single ended data. Similarly, the second transmission generator TS2 may apply a current to the inverted output terminal OUTNB or may receive a current from the inverted output terminal OUTNB in response to the logic level of the single ended data.

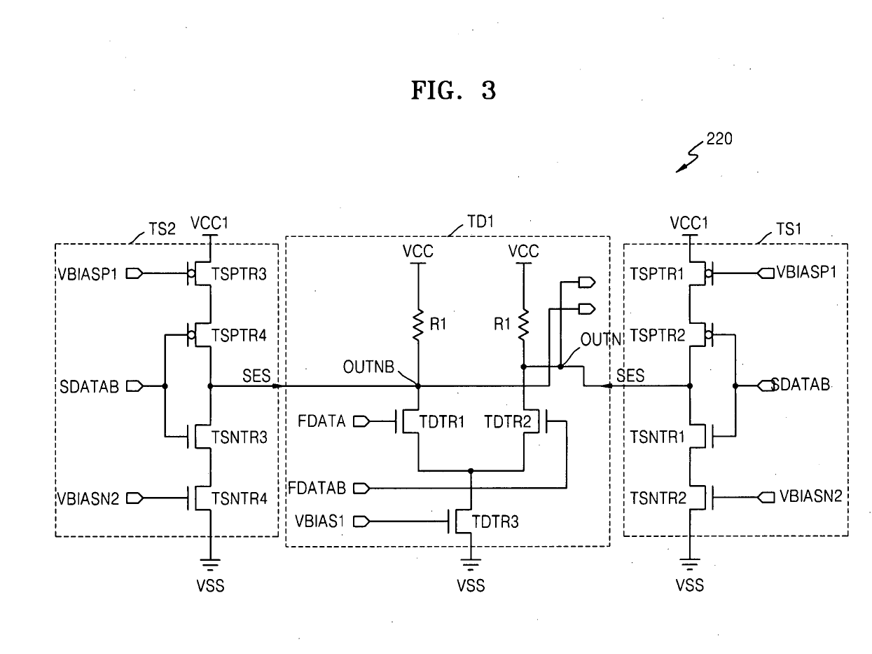

The detailed structure and operation of the transmitter 220 will be explained later with reference to FIG. 3.

An example embodiment of a receiver 230 may be connected to the end of the transmission lines TRL and TRLB opposite the transmitter 220 and may restore the differential signal DIFFS and DIFFSB and the single ended signal SES from the mixed signal MIXS. The receiver 230 may include a receiving differential amplifier RD1, which may restore the differential signal DIFFS and DIFFSB from the mixed signal MIXS, and a single ended signal restoration unit RS1, which may restore the single ended signal SES from the mixed signal MIXS.

FIG. 2 illustrates components used in the signal transmission apparatus 200 to transmit signals from the transmission system 210 to the receiving system 240. However, in addition to what is shown in FIG. 2, the signal transmission apparatus 200 may further include various circuits (not shown) used for transmitting signals from the receiving system 240 to the transmitting system 210. However, these various circuits are omitted herein for the sake of brevity.

The example embodiment of the signal transmission apparatus 200 illustrated in FIG. 2 can send a plurality of signals through a single channel, that is, the transmission lines TRL and TRLB. An example embodiment of a method of transmitting two signals through a single channel is explained below.

Edges of the two signals transmitted through the signal transmission apparatus 200 may have a phase difference of 90° in an example embodiment. One of the two signals may be the differential signal DIFFS and DIFFSB and the other may be a single ended signal SES. The signal transmission apparatus 200 may mix the differential signal DIFFS and DIFFSB and the single ended signal SES having a phase difference of 90°, may transmit the mixed signal through the single channel TRL and TRLB, and may separate the mixed signal back into the two signals.

The differential amplifier TD1 of the transmitter 220 may receive data (not shown) from the system 210, may generate the differential signal DIFFS and DIFFSB and may output the differential signal DIFFS and DIFFSB through the output terminal OUTN and the inverted output terminal OUTB. The single ended signal generator 225 may receive single ended data (not shown) from the transmitting system 210 and may generate the single ended signal SES having a phase difference of 90° with the differential signal DIFFS and DIFFSB.

The single ended signal generator 225 may apply a desired and/or specific current to the output terminal OUTN and the inverted output terminal OUTB or may sink and receive a desired and/or specific current from the output terminal OUTN and the inverted output terminal OUTB to output the mixed signal MIXS including the differential signal DIFFS and DIFFSB and the single ended signal SES from the output terminal OUTN and the inverted output terminal OUTB.

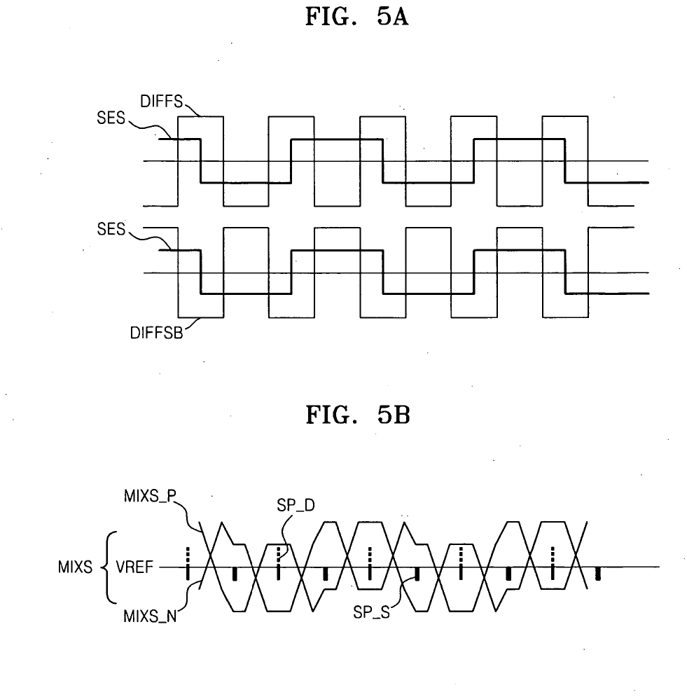

The transmitter 220 executing the above-described method may have various circuit configurations. An example of a circuit configuration is illustrated in FIG. 3. FIG. 3 is an example circuit diagram of the transmitter 220 illustrated in FIG. 2. FIG. 5A is an example waveform diagram of the differential signal DIFFS and DIFFSB and the single ended signal SES, which may be generated in an example embodiment of a transmitter. FIG. 5B is an example waveform diagram of a mixed signal MIXS, which may be obtained by mixing the differential signal DIFFS and DIFFSB and the single ended signal SES.

Referring to FIG. 3, a differential amplifier TD1 may be arranged between a first voltage source VCC and a second voltage source VSS. The differential amplifier TD1 may receive data FDATA and inverted data FDATAB, may amplify a difference between the data FDATA and the inverted data FDATAB and may output the amplified difference to the output terminal OUTN and the inverted output terminal OUTNB.

For example, if a transistor TDTR3 is activated by a bias voltage VBIAS1 and the data FDATA and the inverted data FDATAB are respectively input to transistors TDTR1 and TDTR2, the differential signal DIFFS and DIFFSB is generated and output to the output terminal OUTN and the inverted output terminal OUTNB. In FIG. 3, R1 denotes a resistor having a desired and/or specific resistance.

An example embodiment of a single ended signal generator 225 may include a first transmission generator TS1 and a second transmission generator TS2. The first transmission generator TS1 may apply a current to the output terminal OUTN or may receive a current from the output terminal OUTN in response to a logic level of the single ended data. The second transmission generator TS2 may apply a current to the inverted output terminal OUTNB or may receive a current from the inverted output terminal OUTNB in response to the logic level of the single ended data.

Referring to FIG. 3, an example embodiment of the first transmission generator TS1 may include a first PMOS transistor TSPTR1 and a second PMOS transistor TSPTR2, which may be connected in series between a source of a third voltage VCC1 and the output terminal OUTN. The first PMOS transistor TSPTR1 may be switched, e.g., activated or deactivated, in response to a first bias signal VBIASP1. The second PMOS transistor TSPTR2 may be switched, e.g., activated or deactivated, in response to an inverted single ended data SDATAB. The first transmission generator TS1 may also include a first NMOS transistor TSNTR1 and a second NMOS transistor TSNTR2, which may be connected in series between the output terminal OUTN and the source of the second voltage VSS. The first NMOS transistor TSNTR1 may be switched, e.g., activated or deactivated, in response to the inverted single ended data SDATAB. The second NMOS transistor TSNTR2 may be switched, e.g., activated or deactivated, in response to a second bias signal VBIASN2.

Referring to FIG. 3, an example embodiment of the second transmission generator TS2 may include a third PMOS transistor TSPTR3 and a fourth PMOS transistor TSPTR4, which may be connected in series between the source of the third voltage VCC1 and the inverted output terminal OUTNB. The third PMOS transistor TSPTR3 may be switched, e.g., activated or deactivated, in response to the first bias signal VBIASP1. The fourth PMOS transistor TSPTR4 may be switched, e.g., activated or deactivated, in response to the inverted single ended data SDATAB. The second transmission generator TS2 may also include a third NMOS transistor TSNTR3 and a fourth NMOS transistor TSNTR4, which may be connected in series between the inverted output terminal OUTNB and the source of the second voltage VSS. The third NMOS transistor TSNTR3 may be switched, e.g., activated or deactivated, in response to the inverted single ended data SDATAB. The fourth NMOS transistor TSNTR4 may switched, e.g., activated or deactivated, in response to the second bias signal VBIASN2.

The first bias signal VBIASP1 may have a voltage level that activates the first PMOS transistor TSPTR1 and the third PMOS transistor TSPTR3, and the second bias signal VBIASN2 may have a voltage level that activates the second NMOS transistor TSNTR2 and the fourth NMOS transistor TSNTR4, for example.

The second PMOS transistor TSPTR2 and the fourth PMOS transistor TSPTR4 as well as and the first NMOS transistor TSNTR1 and the third NMOS transistors TSNTR3 may be operated in response to the inverted single ended data SDATAB in an example embodiment. The circuit may be constructed such that the second and fourth PMOS transistors TSPTR2 and TSPTR4 and the first and third NMOS transistors TSNTR1 and TSNTR3 operate in response to the singled ended data.

If the single ended data is at a logic high level, the inverted single ended data SDATAB is at a logic low level and thus, the second PMOS transistor TSPTR2 of the first transmission generator TS1 and the fourth PMOS transistor TSPTR4 of the second transmission generator TS2 may be activated. Accordingly, a current may be applied to the output terminal OUTN and the inverted output terminal OUTNB from the source of the third voltage VCC1.

The applied current may correspond to the single ended signal SES. The single ended signal SES may be mixed with the differential signal DIFFS and DIFFSB, which may be generated by the differential amplifier TD1, and may be output as the mixed signal MIXS (refer to FIGS. 5A and 5B).

If the single ended data is at a logic low level, the inverted single ended data SDATAB is at a logic high level and thus, the first NMOS transistor TSNTR1 of the first transmission generator TS1 and the third NMOS transistor TSNTR3 of the second transmission generator TS2 may be activated. Accordingly, a current may flow from the output terminal OUTN and the inverted output terminal OUTNB into the source of the second voltage VSS.

FIG. 3 is an example circuit configuration and is not intended to limit the circuit configuration of the transmitter 220.

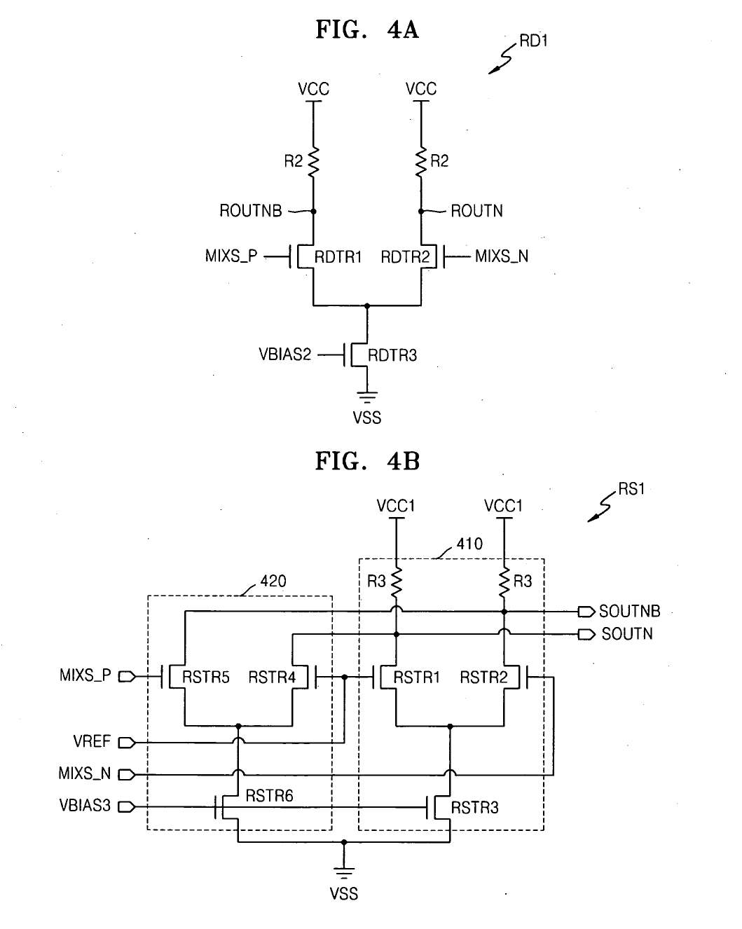

FIG. 4A is a circuit diagram of an example embodiment of a receiving differential amplifier RD1 of the receiver 230 illustrated in FIG. 2. FIG. 4B is a circuit diagram of an example embodiment of a single ended signal restoration unit RS1 of the receiver 230 illustrated in FIG. 2.

Referring to FIG. 4A, the receiving differential amplifier RD1 may restore the differential signal DIFFS and DIFFSB from the mixed signal MIXS.

If a transistor RDTR3 is activated by a bias voltage VBIAS2 and a positive signal MIXS_P and a negative signal MIXS_N of the mixed signal MIXS are respectively input to transistors RDTR1 and RDTR2, the differential signal DIFFS and DIFFSB may be restored to an output terminal ROUTN and an inverted output terminal ROUTNB at a sampling point SP_D of the differential signal (refer to FIG. 5B). In FIG. 4A, R2 denotes a resistor having a desired and/or specific resistance.

An example embodiment of a single ended signal restoration unit RS1 may restore the single ended signal SES from the mixed signal MIXS. The single ended signal restoration unit RS1 may compare a difference between a reference voltage VREF and a maximum value of the DC voltage of the mixed signal MIXS to a difference between the reference voltage VREF and a minimum value of the DC voltage of the mixed signal MIXS at a sampling point SP_S of the mixed signal MIXS and may determine the logic value of the single ended signal SES in response to the comparison result (refer to FIG. 5B).

Referring to FIG. 4B, an example embodiment of a single ended signal restoration unit RS1 may include a first restoration generator 410 and a second restoration generator 420. The first restoration generator 410 may output a difference between the reference voltage VREF and the voltage of the negative signal MIXS_N of the mixed signal MIXS to a restoration output terminal SOUTN and an inverted restoration output terminal SOUTNB. The second restoration generator 420 may output a difference between the reference voltage VREF and the voltage of the positive signal MIXS_P of the mixed signal MIXS to the restoration output terminal SOUTN and the inverted restoration output terminal SOUTNB.

The first restoration generator 410 may include a first restoration transistor RSTR1, a second restoration transistor RSTR2 and a third restoration transistor RSTR3. The first restoration transistor RSTR1 and the second restoration transistor RSTR2 may have first terminals connected in parallel with the source of a third voltage VCC1. The gate of the first restoration terminal RSTR1 may be connected to the reference voltage VREF, and the gate of the second restoration terminal RSTR2 may be connected to the negative signal MIXS_N of the mixed signal MIXS. The second terminals of the first restoration transistor RSTR1 and the second restoration transistor RSTR2 may be connected to a first terminal of the third restoration transistor RSTR3. A second terminal of the third restoration transistor RSTR3 may be connected to the source of the second voltage VSS, and a gate of the third restoration transistor RSTR3 may be applied with a control bias signal VBIAS3.

The first terminal of the first restoration transistor RSTR1 may be coupled to the restoration output terminal SOUTN, and the first terminal of the second restoration transistor RSTR2 may be coupled to the inverted restoration output terminal SOUTNB. In FIG. 4B, R3 denotes a resistor having a desired and/or specific resistance.

The second restoration generator 420 may include a fourth restoration transistor RSTR4, a fifth restoration transistor RSTR5 and a sixth restoration transistor RSTR6. The fourth restoration transistor RSTR4 may have a first terminal connected to the restoration output terminal SOUTN, a gate receiving the reference voltage VREF and a second terminal connected to a first terminal of the sixth restoration transistor RSTR6. The fifth restoration transistor RSTR5 may have a first terminal connected to the inverted restoration output terminal SOUTNB, a gate receiving the positive signal MIXS_P of the mixed signal MIXS and a second terminal connected to the second terminal of the fourth restoration transistor RSTR4 and the first terminal of the sixth restoration transistor RSTR6. The sixth restoration transistor RSTR6 may have a first terminal connected to second terminals of the fourth and fifth restoration transistors RSTR4 and RSTR5, a second terminal connected to the source of the second voltage VSS and a gate receiving the control bias signal VBIAS3.

For example, if the voltage of the positive signal MIXS_P of the mixed signal MIXS is higher than the reference voltage VREF at a sampling point of the single ended signal SES in the mixed signal MIXS, the voltage of the inverted restoration output terminal SOUTNB becomes lower than the voltage of the restoration output terminal SOUTN due to the fourth and fifth restoration transistors RSTR4 and RSTR5.

Further, if the voltage of the negative signal MIXS_N of the mixed signal MIXS is lower than the reference voltage VREF at the sampling point of the single ended signal SES in the mixed signal MIXS, the voltage of the restoration output terminal SOUTN becomes lower than the voltage of the inverted restoration output terminal SOUTNB due to the first and second restoration transistors RSTR1 and RSTR2.

In this example, if a difference between the voltage of the positive signal MIXS_P of the mixed signal MIXS and the reference voltage VREF is larger than a difference between the voltage of the negative signal MIXS_N of the mixed signal MIXS and the reference voltage VREF, the signal output from the inverted restoration output terminal SOUTNB is low and the signal output from the restoration output terminal SOUTN is high. That is, the logic value of the single ended signal SES may be determined in response to the absolute value of the difference between the reference voltage VREF and the positive signal MIXS_P of the mixed signal MIXS and the absolute value of the difference between the reference voltage VREF and the negative signal MIXS_N of the mixed signal MIXS.

The circuit configurations illustrated in FIGS. 4A and 4B are example embodiments and are not intended to limit the receiver 230 shown in FIG. 2.

FIG. 5A illustrates an example differential signal DIFFS and DIFFSB and an example single ended signal SES. The differential signal DIFFS and DIFFSB has a phase difference of 90° relative to the single ended signal SES. FIG. 5B illustrates an example mixed signal MIXS obtained from the signals illustrated in FIG. 5A. The positive signal MIXS_P of the mixed signal MIXS may be obtained by mixing the component DIFFS of the differential signal and the single ended signal SES, as illustrated in the upper part of FIG. 5A. The negative signal MIXS_N of the mixed signal MIXS may be obtained by mixing the component DIFFSB of the differential signal and the single ended signal SES, as illustrated in the lower part of FIG. 5A.

Referring to FIG. 5A, the frequency of the differential signal DIFFS and DIFFSB may be higher than the frequency of the single ended signal SES. Further, the DC level of the differential signal DIFFS and DIFFSB may be higher than that of the single ended signal SES.

To make the DC level of the differential signal DIFFS and DIFFSB higher than that of the single ended signal SES, the third voltage and the first voltage may be controlled. For example, the DC level of the differential signal DIFFS and DIFFSB becomes higher than the DC level of the single ended signal SES when the third voltage is lower than the first voltage.

The differential signal DIFFS and DIFFSB and the single ended signal SES having the aforementioned characteristic may be transmitted through a single channel by an example embodiment of the signal transmission apparatus 200.

In an example embodiment, the phase of the differential signal DIFFS and DIFFSB and the single ended signal SES is not the same. According to an example embodiment, the phase difference between the differential signal DIFFS and DIFFSB and the single ended signal SES is about 90°.

It is noted that it may be difficult to separate the differential signal DIFFS and DIFFSB and the single ended signal SES from the mixed signal MIXS if there is no phase difference between the differential signal DIFFS and DIFFSB and the single ended signal SES.

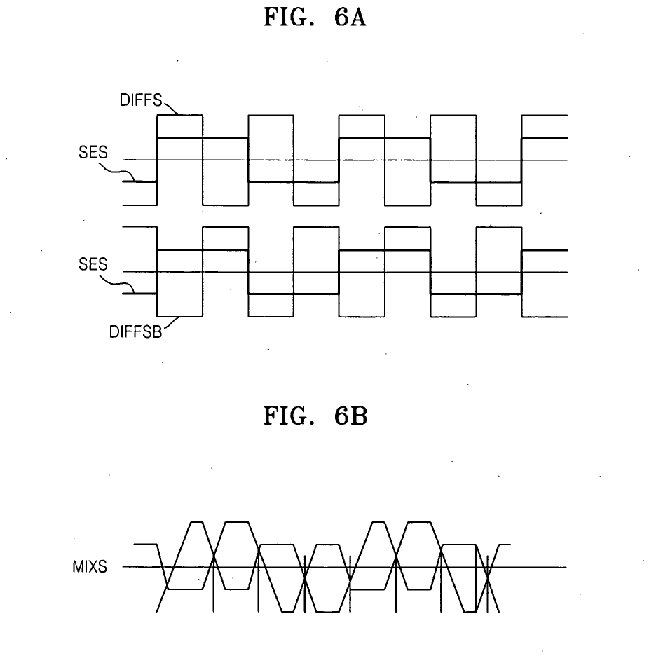

FIG. 6A is an example waveform diagram of the differential signal DIFFS and DIFFSB and the single ended signal SES when there is no phase difference between the differential signal DIFFS and DIFFSB and the single ended signal SES. FIG. 6B is an example waveform diagram of a mixed signal obtained by mixing the differential signal and the single ended signal of FIG. 6A. Referring to FIGS. 6A and 6B, the differential signal DIFFS and DIFFSB and the single ended signal SES have the same phase and thus, the mixed signal MIXS obtained by mixing the differential signal DIFFS and DIFFSB and the single ended signal SES may have an irregular magnitude and thus, it may be difficult to select a sampling point for separating the differential signal DIFFS and DIFFSB and the single ended signal SES from the mixed signal MIXS.

According to an example embodiment, to transmit two signals through a single channel, the two signals should not have the same phase. In an example embodiment of the signal transmission apparatus 200, the edge rate of the mixed signal MIXS may be less than the edge rate of the differential signal having a higher frequency while the differential signal and the single ended signal are being transmitted through a single channel. Furthermore, according to an example embodiment, the duty ratio of the differential signal may be maintained at approximately 50%.

According to an example embodiment, the differential signal may be data of a semiconductor memory device and the single ended signal may be a command signal or an address signal of the semiconductor memory device, for example. That is, an example embodiment of the signal transmission apparatus may be used as a component of a semiconductor memory device to transmit a command signal or an address signal along with data through a single channel.

An example embodiment of a signal transmission apparatus may include a mixing unit and a restoration unit. A channel may be connected between the mixing unit and the restoration unit. The mixing unit may mix two signals having a phase difference of approximately 90° to produce a single mixed signal. The restoration unit may restore the two signals from the mixed signal, and the channel may be used to transmit the mixed signal.

The mixing unit may correspond to the transmitter 220 of the example embodiment of the signal transmission apparatus 200 illustrated in FIG. 2. The restoration unit may correspond to the receiver 230, and the channel may correspond to the transmission lines TRL and TRLB shown in FIG. 2. Accordingly, detailed explanations of the mixing unit, restoration unit and channel are omitted for the sake of brevity.

An example embodiment of a signal transmission method for transmitting a differential signal and a single ended signal using a single channel may include transmitting a mixed signal obtained by mixing the differential signal and the single ended signal through a single channel, and restoring the differential signal and the single ended signal from the mixed signal. The frequency of the differential signal may be higher than the single ended signal.

Transmitting the mixed signal through the single channel may correspond to the operation of the transmitter 220 of the signal transmission apparatus 200 illustrated in FIG. 2 and described above. Restoring the differential signal and the single ended signal may correspond to the operation of the receiver 230. Accordingly, detailed explanations of transmitting the mixed signal and restoring the differential signal and the single ended signal are omitted for the sake of brevity.

As described above, an example embodiment of a signal transmission apparatus and an example embodiment of a method for transmitting signals through a single channel may reduce circuit area of a device and/or apparatus.

While example embodiments have been particularly shown and described in the drawings and specification, it will be understood by those of ordinary skill in the art that various changes in form and details may be made therein without departing from the spirit and scope defined by the following claims.

What is claimed is:

1. A signal transmission apparatus transmitting and receiving a mixed signal, comprising:
a transmitter transmitting the mixed signal obtained by mixing a differential signal with a single ended signal; and
a receiver restoring the differential signal and the single ended signal from the mixed signal,
wherein an edge of the single ended signal is out of phase with an edge of the differential signal.

2. The signal transmission apparatus of claim 1, wherein the mixed signal is transmitted using transmission lines of a channel, the transmitter is connected to one end of the transmission lines and the receiver is connected to another end of the transmission lines.

3. The signal transmission apparatus of claim 1, wherein the single ended signal has a phase difference of 90° with the differential signal.

4. The signal transmission apparatus of claim 1, wherein a frequency of the differential signal is higher than the frequency of the single ended signal.

5. The signal transmission apparatus of claim 1, wherein a DC level of the differential signal is higher than a DC level of the single ended signal.

6. The signal transmission apparatus of claim 1, wherein the transmitter comprises:
a differential amplifier receiving data, generating the differential signal and outputting the differential signal through an output terminal and an inverted output terminal; and
a single ended signal generator receiving single ended data and applying a current to the output terminal and the inverted output terminal or receiving a current from the output terminal and the inverted output terminal to output the mixed signal from the output terminal and the inverted output terminal.

7. The signal transmission apparatus of claim 6, wherein the single ended signal generator comprises:
a first transmission generator applying a current to the output terminal or receiving a current from the output terminal in response to a logic level of the single ended data; and
a second transmission generator applying a current to the inverted output terminal or receiving a current from the inverted output terminal in response to the logic level of the single ended data.

8. The signal transmission apparatus of claim 7, wherein the first transmission generator comprises:
a first PMOS transistor switching in response to a first bias signal;
a second PMOS transistor connected in series with the first PMOS transistor between a third voltage source and the output terminal, the second PMOS transistor switching in response to an inverted single ended data obtained by inverting the single ended data;
a first NMOS transistor switching in response to the inverted single ended data;
a second NMOS transistor connected in series with the first NMOS transistor between the output terminal and a second voltage source, the second NMOS transistor switching in response to a second bias signal; and the second transmission generator comprises:
a third PMOS transistor switching in response to the first bias signal;
a fourth PMOS transistors connected in series with the third PMOS transistor between the third voltage source and the inverted output terminal, the fourth PMOS transistor switching in response to the inverted single ended data;
a third NMOS transistor switching in response to the inverted single ended data; and
a fourth NMOS transistor connected in series with the third NMOS transistor between the inverted output terminal and the second voltage source, the fourth NMOS transistor switching in response to the second bias signal.

9. The signal transmission apparatus of claim 1, wherein the receiver comprises:
a receiving differential amplifier restoring the differential signal from the mixed signal; and
a single ended signal restoration unit restoring the single ended signal from the mixed signal.

10. The signal transmission apparatus of claim 9, wherein the single ended signal restoration unit compares a difference between a reference voltage and a maximum value of a DC voltage of the mixed signal to a difference between the reference voltage and a minimum value of the DC voltage of the mixed signal at a sampling point of the mixed signal and determines a logic value of the single ended signal in response to a comparison result.

11. The signal transmission apparatus of claim 10, wherein the single ended signal restoration unit comprises:
a first restoration generator outputting a difference between the reference voltage and the voltage of a negative signal of the mixed signal to a restoration output terminal and an inverted restoration output terminal; and
a second restoration generator outputting a difference between the reference voltage and the voltage of a positive signal of the mixed signal to the restoration output terminal and the inverted restoration output terminal.

12. The signal transmission apparatus of claim 11, wherein
the first restoration generator comprises:
a first restoration transistor having a first terminal connected to the restoration output terminal and a third voltage source, a gate receiving the reference voltage and a second terminal;
a second restoration transistor having a first terminal connected to the inverted restoration output signal and the third voltage source, a gate receiving the negative signal of the mixed signal and a second terminal connected to the second terminal of the first restoration transistor; and
a third restoration transistor having a first terminal connected to the second terminal of the first restoration transistor and the second terminal of the second restoration transistors, a gate to which a control bias signal is applied and a second terminal connected to the second voltage source, and
the second restoration generator comprises:
a fourth restoration transistor having a first terminal connected to the restoration output terminal, a gate receiving the reference voltage and a second terminal;
a fifth restoration transistor having a first terminal connected to the inverted restoration output terminal, a gate receiving the positive signal of the mixed signal and a second terminal; and
a sixth restoration transistor having a first terminal connected to the second terminal of the fourth restoration transistor and a second terminal of the fifth restoration transistors, a gate to which a control bias signal is applied, and a second terminal connected to the second voltage source.

13. The signal transmission apparatus of claim 1, wherein the differential signal is data of a semiconductor memory device and the single ended signal is a command signal or an address signal of the semiconductor memory device.

14. A signal transmission apparatus comprising:
a mixing unit mixing two out of phase signals having a phase difference of 90° to produce a single mixed signal; and
a restoration unit restoring the two signals from the mixed signal.

15. The signal transmission apparatus of claim 14, wherein the mixing unit and the restoration unit are connected by a channel used to transmit the mixed signal.

16. The signal transmission apparatus of claim 14, wherein one of the two signals is a differential signal and the other is a single ended signal.

17. The signal transmission apparatus of claim 16, wherein a frequency of the differential signal is higher than a frequency of the single ended signal.

18. The signal transmission apparatus of claim 16, wherein a DC level of the differential signal is higher than a DC level of the single ended signal.

19. The signal transmission apparatus of claim 15, wherein the channel includes two transmission lines transmitting the differential signal.

20. The signal transmission apparatus of claim 14, wherein the mixing unit comprises:
a differential amplifier receiving data, generating the differential signal and outputting the differential signal through an output terminal and an inverted output terminal; and
a single ended signal generator receiving single ended data and applying a current to the output terminal and the inverted output terminal or receiving a current from the output terminal and the inverted output terminal to output the mixed signal from the output terminal and the inverted output terminal.

21. The signal transmission apparatus of claim 14, wherein the restoration unit comprises:
a receiving differential amplifier restoring the differential signal from the mixed signal; and
a single ended signal restoration unit restoring the single ended signal from the mixed signal,
wherein the single ended signal restoration unit compares a difference between a reference voltage and a maximum value of a DC voltage of the mixed signal to a difference between the reference voltage and a minimum value of the DC voltage of the mixed signal at a sampling point of the mixed signal and determines a logic value of the single ended signal in response to a comparison result.

22. A signal transmission method for transmitting a differential signal and a single ended signal using a single channel comprising:
mixing a differential signal with a single ended signal to obtain a mixed signal;
transmitting the mixed signal through a single channel; and
restoring the differential signal and the single ended signal from the mixed signal,
wherein a frequency of the differential signal is higher than a frequency of the single ended signal.

23. The signal transmission method of claim 22, wherein transmitting the mixed signal comprises:
receiving data;
generating the differential signal in response to the received data;
outputting the differential signal through an output terminal and an inverted output terminal;
receiving single ended data; and
mixing the differential signal with the single ended signal at the output terminal and the inverted output terminal based on one of a current applied to the output terminal and the inverted output terminal and a current received from the output terminal and the inverted output terminal.

24. The signal transmission method of claim 22, wherein restoring the differential signal and the single ended signal comprises:
restoring the differential signal from the mixed signal;
comparing a difference between a reference voltage and a maximum value of a DC voltage of the mixed signal to a difference between the reference voltage and a minimum value of the DC voltage of the mixed signal at a sampling point of the mixed signal; and
determining a logic value of the single ended signal in response to the comparing.

25. The signal transmission method of claim 22, wherein an edge of the single ended signal has a phase difference of 90° with an edge of the differential signal.

26. The signal transmission method of claim 22, wherein a DC level of the differential signal is higher than a DC level of the single ended signal.

27. The signal transmission method of claim 22, wherein the differential signal is data of a semiconductor device and the single ended signal is a command signal or an address signal of the semiconductor device.

28. A method of transmitting a signal comprising:
mixing a differential signal with a single ended signal to obtain a mixed signal; and
transmitting the mixed signal through a channel,
wherein the single ended signal has a phase difference of 90° with the differential signal.
